(19) United States
(12) Patent Application Publication
(10) Pub. No.: US 2014/0229396 A1
(43) Pub. Date: Aug. 14, 2014

(54) SYSTEM AND METHOD FOR PROVIDING APPLICANT SPECIFIC PREMIUM CANDIDATE PROFILES

(71) Applicant: Jonathan Sack, Los Angeles, CA (US)

(72) Inventor: Jonathan Sack, Los Angeles, CA (US)

(21) Appl. No.: 14/258,452

(22) Filed: Apr. 22, 2014

Related U.S. Application Data
(60) Provisional application No. 61/814,571, filed on Apr. 22, 2013.

(51) Int. Cl. G06Q 10/10

(52) U.S. Cl. CPC G06Q 10/1053
USPC 705/321

(57) ABSTRACT

The present invention generally relates to employment web services. Specifically, this invention relates to a web-based system and method for providing applicant specific premium candidate profiles. Such profiles are engineered to allow employers and employees to be better matched strategically through usage of multimedia content and directed employment information and related content.

### CROSS REFERENCE TO RELATED APPLICATIONS

This application claims the benefit of the following provisional applications, each of which is hereby incorporated by reference in its entirety: U.S. Pat. App. No. 61/814,571 filed on Apr. 22, 2013 and entitled “SYSTEM AND METHOD FOR PROVIDING APPLICANT SPECIFIC PREMIUM CANDIDATE PROFILES.”

### FIELD OF THE INVENTION

The present invention generally relates to employment web services. Specifically, this invention relates to a web-based system and method for providing applicant specific premium candidate profiles. Such profiles are engineered to allow employers and employees to be better matched strategically through usage of multimedia content and directed employment information and related content.

### BACKGROUND

Present systems for employment web services are limited to providing a resume and a picture of a potential employee for potential employers to review. The information is linear and in whatever format the potential employee organized the information into. Given that the amount of information available about a potential employee varies widely, and that potential employees with significant experience and credentials can consume a lot of space, a lot of important information can get lost in the noise.

Further, since each potential employer may be looking for specific traits, qualities or experience in potential employees, this ad hoc method of simply displaying information provided in a resume view is inefficient at best for potential employers looking to target these specific traits, qualities or experiences as they have to parse through all the information simply to find what they are looking for.

These failures of present employment web services result in employers either not being able to find the right potential employee for their positions or spending inordinate amounts of time to do so. The other option for potential employers is to utilize professional headhunters at additional cost and expense to the employer.

There is therefore a need in the art for a system and method for providing applicant specific premium candidate profiles engineered to allow employers and employees to be better matched strategically through usage of multimedia content and directed employment information and related content. These and other features and advantages of the present invention will be explained and will become obvious to one skilled in the art through the summary of the invention that follows.

### SUMMARY OF THE INVENTION

Accordingly, it is an aspect of the present invention to provide a system and method for providing applicant specific premium candidate profiles engineered to allow employers and employees to be better matched strategically through usage of multimedia content and directed employment information and related content.

According to an embodiment of the present invention, a computer implemented web-based method for providing applicant specific premium candidate profiles, said method comprising the steps of: receiving a plurality of profile information points from a user; processing said plurality of profile information points for compatibility with a premium candidate profile; generating a premium candidate profile based on said plurality of profile information points; receiving an employee search request from a potential employer; identifying search criteria based at least in part on said employee search; retrieving, from a data store, a set of premium candidate profiles comprising one or more premium candidate profiles, wherein each of said one or more premium candidate profiles matches at least a portion of said search criteria; and providing said set of premium candidate profiles to said potential employer.

According to an embodiment of the present invention, the method further comprises the steps of: receiving one or more premium profile information points; processing said one or more premium profile information points; and augmenting said premium candidate profile with said premium profile information points.

According to an embodiment of the present invention, the premium profile information points are selected from the group comprising brag books, video profiles and selective questionnaire responses.

According to an embodiment of the present invention, the profile information points are selected from the group comprising candidate personal information, candidate experience information, candidate education information and candidate accomplishment information.

According to an embodiment of the present invention, the method further comprises the steps of: generating a mini-profile view for each premium candidate profile contained in said set of premium candidate profiles; generating a display comprising mini-profile views generated for each premium candidate profile; and providing said display to said potential employer.

According to an embodiment of the present invention, the method further comprises the step of: providing a communication connection for instant communication between said potential employer and a candidate associated with said premium candidate profile, wherein said communication connection is initiated via interaction with said mini-profile view.

According to an embodiment of the present invention, the method further comprises the steps of: generating a candidate ranking based on a matching of said search criteria with profile information associated with each of said premium candidate profile in said set of premium candidate profiles; and providing candidate ranking to said potential employer.

According to an embodiment of the present invention, the method further comprises the steps of: receiving an information request from said potential employer related to one of said premium candidate profiles in said set of premium candidate profiles; transmitting said information request to a candidate associated with said one of said premium candidate profiles in said set of premium candidate profiles; receiving supplementary profile information associated with said information request from said candidate; processing said supplementary profile information associated with said information request from said candidate; updating said one of said premium candidate profiles in said set of premium candidate profiles based at least in part on said supplementary profile information; generating an updated candidate ranking, wherein an updated premium candidate profile changes the candidate ranking; and providing said updated candidate ranking to said potential employer.

According to an embodiment of the present invention, the method further comprises the steps of: receiving a candidate contact request from said potential employer, wherein said candidate contact request identifies a premium candidate profile contained in said set of premium candidate profiles; identifying contact information associated with a candidate in identified premium candidate profile; and initiating contact between said potential employer and said candidate.

According to an embodiment of the present invention, the method further comprises the steps of: dividing the profile information points into a plurality of separate content sections; and associating said separate content sections with said premium candidate profile.

According to an embodiment of the present invention, a computer implemented web-based system for providing applicant specific premium candidate profiles, said system comprising: an advanced profile generation module, comprising computer-executable code stored in non-volatile memory, an advanced profile analysis module, comprising computer-executable code stored in non-volatile memory, a processor, and a communications means, wherein said advanced profile generation module, said advanced profile analysis module, said processor, and said communications means are operably connected and are configured to: receive a plurality of profile information points from a user; process said plurality of profile information points for compatibility with a premium candidate profile; generate a premium candidate profile based on said plurality of profile information points; receive an employee search request from a potential employer; identify search criteria based at least in part on said employee search; retrieve, from a data store, a set of premium candidate profiles comprising one or more premium candidate profiles, wherein each of said one or more premium candidate profiles matches at least a portion of said search criteria; and provide said set of premium candidate profiles to said potential employer.

According to an embodiment of the present invention, the advanced profile generation module, said advanced profile analysis module, said processor, and said communications means are further configured to: receive one or more premium profile information points; process said one or more premium profile information points; and augment said premium candidate profile with said premium profile information points.

According to an embodiment of the present invention, the advanced profile generation module, said advanced profile analysis module, said processor, and said communications means are further configured to: generate a mini-profile view for each premium candidate profile contained in said set of premium candidate profiles; generate a display comprising mini-profile views generated for each premium candidate profile; and provide said display to said potential employer.

According to an embodiment of the present invention, the advanced profile generation module, said advanced profile analysis module, said processor, and said communications means are further configured to: generate a candidate ranking based on a matching of said search criteria with profile information associated with each of said premium candidate profile in said set of premium candidate profiles; and provide candidate ranking to said potential employer.

According to an embodiment of the present invention, the advanced profile generation module, said advanced profile analysis module, said processor, and said communications means are further configured to: receive an information request from said potential employer related to one of said premium candidate profiles in said set of premium candidate profiles; transmit said information request to a candidate associated with said one of said premium candidate profiles in said set of premium candidate profiles; receive supplementary profile information associated with said information request from said candidate; process said supplementary profile information associated with said information request from said candidate; update said one of said premium candidate profiles in said set of premium candidate profiles based at least in part on said supplementary profile information; generate an updated candidate ranking, wherein an updated premium candidate profile changes the candidate ranking; and provide said updated candidate ranking to said potential employer.

According to an embodiment of the present invention, the advanced profile generation module, said advanced profile analysis module, said processor, and said communications means are further configured to: receive a candidate contact request from said potential employer, wherein said candidate contact request identifies a premium candidate profile contained in said set of premium candidate profiles; identify contact information associated with a candidate in identified premium candidate profile; and initiate contact between said potential employer and said candidate.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

For the purposes of illustration, there are forms shown in the drawings that are presently preferred, it being understood, however, that the invention is not limited to the precise arrangements and instrumentalities shown.

FIG. 1 illustrates a network schematic of a system, in accordance with an embodiment of the present invention.

FIG. 2 illustrates a schematic overview of a computing device, in accordance with an embodiment of the present invention.

FIGS. 3A-3C show various graphical user interfaces utilized in accordance with an embodiment of the present invention.

FIG. 4 show a graphical user interface showing a list of mini-candidate profiles in accordance with an embodiment of the present invention.

FIGS. 5A-5F show various graphical user interfaces utilized in accordance with an embodiment of the present invention.

FIG. 6 show various graphical user interfaces utilized in accordance with an embodiment of the present invention.

FIG. 7 illustrates a system schematic of a computing system for providing advanced candidate profiles, in accordance with an embodiment of the present invention.

FIG. 8 illustrates an exemplary process flow, in accordance with an embodiment of the present invention.

FIG. 9 illustrates an exemplary process flow, in accordance with an embodiment of the present invention.

### DETAILED SPECIFICATION

The present invention generally relates to employment web services. Specifically, this invention relates to a web-based system and method for providing applicant specific premium candidate profiles. Such profiles are engineered to allow employers and employees to be better matched strategically through usage of multimedia content and directed employment information and related content.

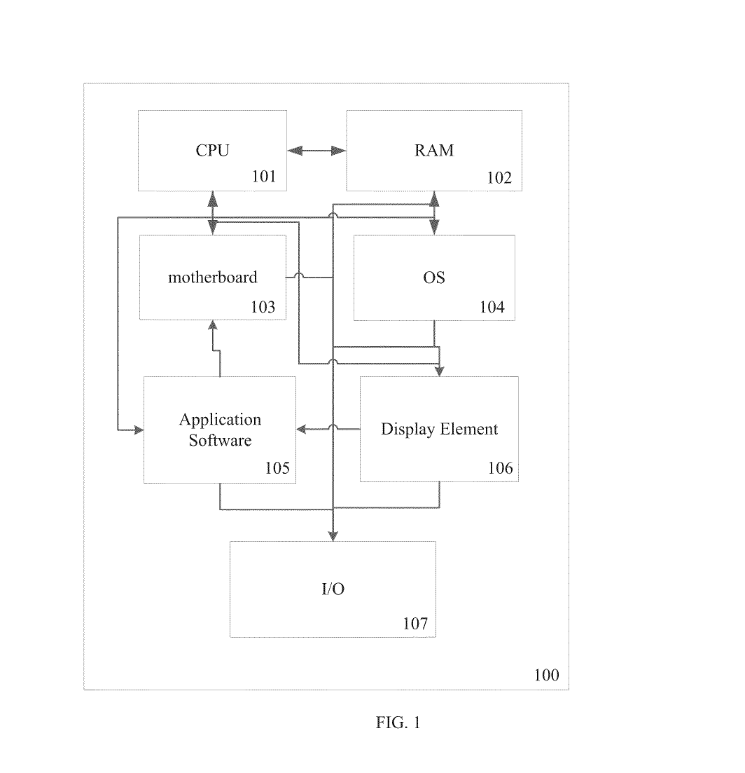

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more display elements 106 and one or more input/output devices/means 107. Examples of computing devices usable with embodiments of the present invention include, but are not limited to, personal computers, smart phones, laptops, mobile computing devices and tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device. In the case of servers, the utilization of display elements 106 may be optional or provided remote from the server and accessible via an interface that would be understood by one of ordinary skill in the art.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention a user may be able to compose data offline that will be consumed by the system when the user is later connected to a network.

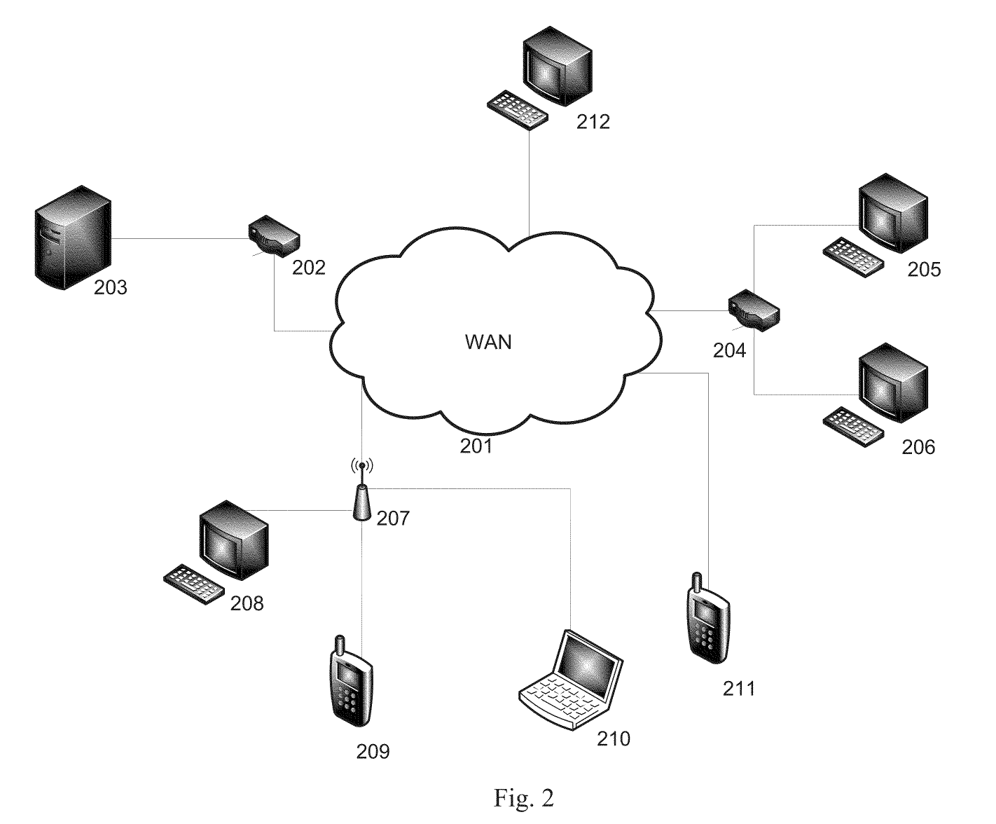

Referring to FIG. 2, a schematic overview of a system in accordance with an embodiment of the present invention is shown. The system is comprised of one or more application servers 203 for electronically storing information used by the system. Applications in the server 203 may retrieve and manipulate information in storage devices and exchange information through a WAN 201 (e.g., the Internet). Applications in server 203 may also be used to manipulate information stored remotely and process and analyze data stored remotely across a WAN 201 (e.g., the Internet).

According to an exemplary embodiment, as shown in FIG. 2, exchange of information through the WAN 201 or other network may occur through one or more high speed connections. In some cases, high speed connections may be over-the-air (OTA), passed through networked systems, directly connected to one or more WANs 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to WAN 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via WAN 201 or other network in numerous ways. For instance, a component may connect to the system i) through a computing device 212 directly connected to the WAN 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the WAN 201. One of ordinary skill in the art would appreciate that there are numerous ways that a component may connect to server 203 via WAN 201 or other network, and embodiments of the present invention are contemplated for use with any method for connecting to server 203 via WAN 201 or other network. Furthermore, server 203 could be comprised of a personal computing device, such as a smartphone, acting as a host for other computing devices to connect to. While many components of the system are web-based or otherwise utilize computing devices over networks, such as the internet, certain aspects of the invention may be provided by analog systems (e.g., landline telephones could be utilized to call and leave voicemails which may be digitized and converted into useable components within the system).

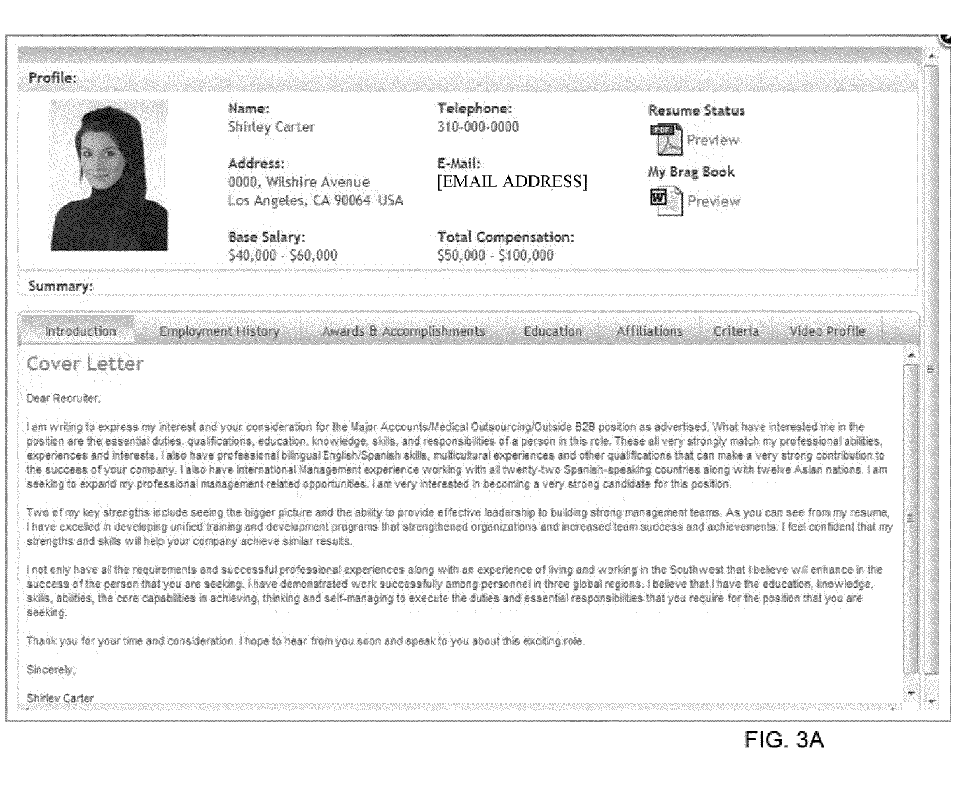

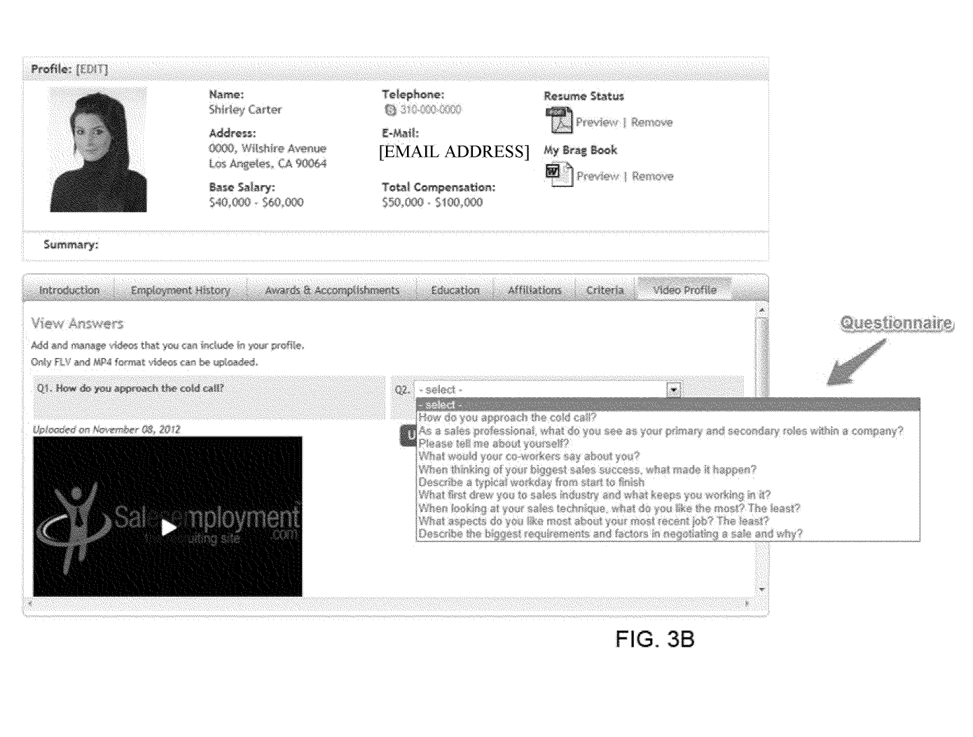

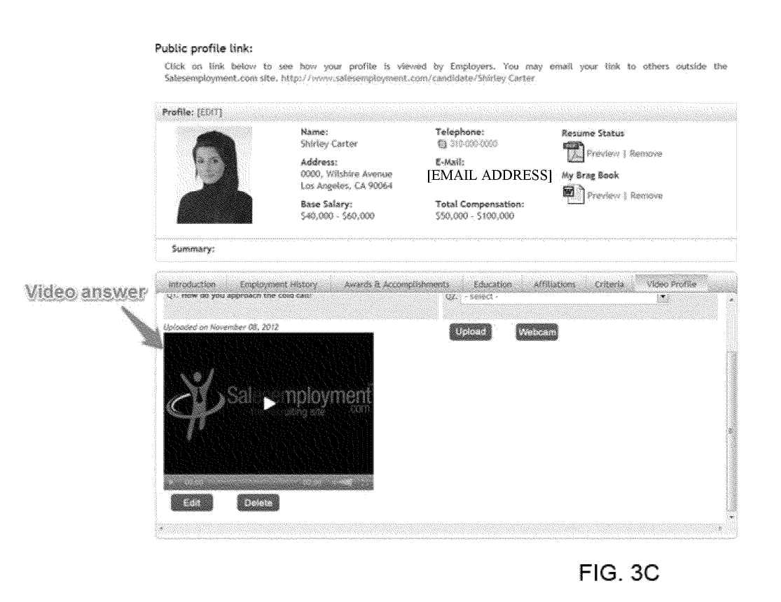

According to an embodiment of the present invention, the system is configured to allow candidates for employment the ability to highlight more than just the information that would be present on a standard resume/CV. In enabling this functionality, the system may be configured to provide a plurality of profile components divided amongst one or more organizational elements. Further, embodiments of the present invention may provide multiple views of the profile components, allowing potential employers the ability to organize and sort through candidates with ease, focusing solely on the profile components that are important to that employer (See, FIGS. 3A-3C).

According to an embodiment of the present invention, the system utilizes a premium candidate profile module and an organization module that work together and are operably and/or communicatively connected to one or more of a processor, a memory, a storage medium, a communications means and/or any number of computing devices utilized by users of the system. One of ordinary skill in the art would appreciate that the system could be implemented with additional or fewer components, and embodiments of the present invention are contemplated for use with any number of components.

According to an embodiment of the present invention, the premium candidate profile module is configured to receive a plurality of profile information points from a candidate and convert these profile information points into one or more appropriate profile components for use by the system. Profile information points may include, but are not limited to, candidate personal information (e.g., name, address, phone number, e-mail address), candidate experience information (e.g., previous employers, years of experience, job titles, recommendations), candidate education information (e.g., number of years completed, schools attended, grade point averages, majors, affiliations), candidate accomplishment information (e.g., awards, accomplishments, recognitions) or any combination thereof. In preferred embodiments of the present invention, profile information may also be comprised of one or more premium profile information components, including, but not limited to: brag books, video profiles, selective questionnaire responses or any combination thereof. One of ordinary skill in the art would appreciate that there are numerous types of profile information that could be utilized with embodiments of the present invention, and embodiments of the present invention are contemplated for use with any type of profile information.

According to an embodiment of the present invention, premium profile information is utilized to allow candidates to stand out from the others. Premium profile information allows for industry specific details to be utilized in the pre-screening of candidates by employers. For instance, the inclusion of a brag book for those in the sales industry is crucial in allowing employers the ability to ascertain the skill of a sales person. Further, video profiles allow employers to view the candidate, their body language, their speech quality and other physical elements that would otherwise be unascertainable via a written profile alone.

In certain embodiments, the system may be configured to analyze video profiles for key information points based on objective analysis of various components of the video. For instance, video could be analyzed for variations in body language and speech components that would denote physical or mental states (e.g., nervousness, confidence, anxiousness, truthfulness). In certain embodiments, analysis of the video may only be available to employers. In this manner, candidates are not exposed to their own reactions and attempt to fix/correct videos. In other embodiments, video analysis and/or commentary may be provided to the candidate so that they can attempt to correct or otherwise be conscious of their physical or mental states.

According to an embodiment of the present invention, the premium profile information may include selective questionnaire responses. In these embodiments, candidates may be allowed to select one or more questions from a list of questions and have their responses recorded, either via text, audio, video or any combination thereof. In certain embodiments, the questions may be predetermined, such as those selected for the specific industry of job type. In other embodiments, the questions may be randomly selected. In other embodiments, the questions may be selected from questions identified by a particular employer or set of employers.

In certain embodiments where sets of questions have been previously identified, the system may be configured to only ask or allow the candidate to choose a subset of questions selected from the full set of questions. There are multiple advantages to this method. First, it allows employers to limit the amount of data they have to review for each individual candidate. Second, a lot can be identified through the selection of questions by the candidate, both in the questions the candidate choose to answer as well as the questions the candidate choose not to answer. For instance, if a set of questions included questions related to working in a group and working individually, and a candidate were to select questions only about working as an individual, this could lead to the analysis that the candidate was less of a team player and more of an individualist. Depending on the type of questions and the number of questions to be selected, various personality elements can be teased out simply by the selection of the question, without reference to the content of the answer. Used in conjunction with the response, the questions selected by the candidate could be informative for the employer.

In certain embodiments of the present invention, the system may be configured to restrict access to one or more subsequent questions based on the selection of a first question to respond to. In other embodiments, candidates may be initially provided a limited set of question selection options, and each subsequent response would unlock or allow the candidate to answer other questions based on selection of the previous question. In this manner, the system can be configured to ask questions that are relevant based on previously asked questions.

According to an embodiment of the present invention, once the candidate has provided all the profile information points and premium profile information to the system, the system will generate a premium profile from the profile information points and premium profile information and associate the premium profile with the candidate. The process of generating a premium profile from the profile information points and premium profile information is generally handled by the organization module. In preferred embodiments, the organization module is configured to retrieve the profile information points and premium profile information from one or more storage mediums and/or databases for utilization in developing the premium profile. The organization module assembles the various data points into a conceptually organized profile, making review by potential employers both convenient and streamlined.

According to an embodiment of the present invention, the premium profile generated by the organization module may be comprised of a plurality of separated information components. In preferred embodiments, each one of the plurality of separated information components is distinct from the others by both content and display, with only one (or some limited subset) of separated information components being displayed at a time. One of ordinary skill in the art would appreciate that the generation of the content of the separated information components may occur at the organization module, but the actual display of the components will be at an end-user's computing device. Generally, this is effected through the transfer of data from the system to the end-user's computing device where it will be interpreted and displayed by a browser or other program configured to display received content (e.g., mobile application).

According to an embodiment of the present invention, the plurality of separated information components may be comprised of any display element appropriate for separating content, both on purpose and display. For instance, the separated information components may be tabs with titles denoting the content of each tab, separating the underlying content and displaying one or some subset of the tabs at a time (See FIGS. 3A-3C). According to embodiments of the present invention, the plurality of separated information components may include, but are not limited to, tabs, buttons, sliders, or any combination thereof. One of ordinary skill in the art would appreciate that there are numerous types of separated information components that could be utilized with embodiments of the present invention, and embodiments of the present invention are contemplated for use with any type of separated information component.

According to an embodiment of the present invention, the plurality of separated information components may include, but are not limited to, one or more tabs selected from the group comprising an introduction tab, an employment history tab, an awards & accomplishments tab, an education tab, an affiliations tab, a criteria tab and a video profile tab (See FIGS. 3A-3C). In a preferred embodiment of the present invention, only one of the tabs would be displayed at a time, allowing the others to be collapsed or otherwise not viewable. This works to limit information overload and allow potential employers to focus on the information that is important to them.

According to an embodiment of the present invention, the system may be configured to allow employers to search and view candidates based only on content of specific tabs (e.g., education & work experience). In this manner, employers may be allowed to narrow down the field of information that is relevant to their candidate searches.

Through use of the distinctly separated content (e.g., tabs), the system is able to create a two dimensional profile comprised of candidate information (e.g., profile information and premium profile information). Through the inclusion of video and other premium profile information, the system effectively makes a three dimensional profile comprised of distinctly separated candidate profile information, video and premium profile information.

According to an embodiment of the present invention, employers may be provided the ability to search for and view only candidates who have responded to, provided or selected specific premium profile information. In this manner, employers can limit their candidate searches to candidates who have provided information specifically relevant to their needs or otherwise have characteristics the employer has deemed of critical importance. For instance, an employer may search for candidates who have responded to specific video questions and provided responses to those specific video questions. In other embodiments, employers may search for candidates that have provided brag books. One of ordinary skill in the art would appreciate that there are numerous methods employers could be allowed to limit their candidate search based on provided profile information points and premium profile information, and embodiments of the present invention are contemplated for use with any such method.

In certain embodiments, recruiters and employers may be allowed to submit requests to candidates for additional premium profile information not currently available on a candidate profile page. For instance, a recruiter may be able to request that a particular candidate answer a specific question with a video response.

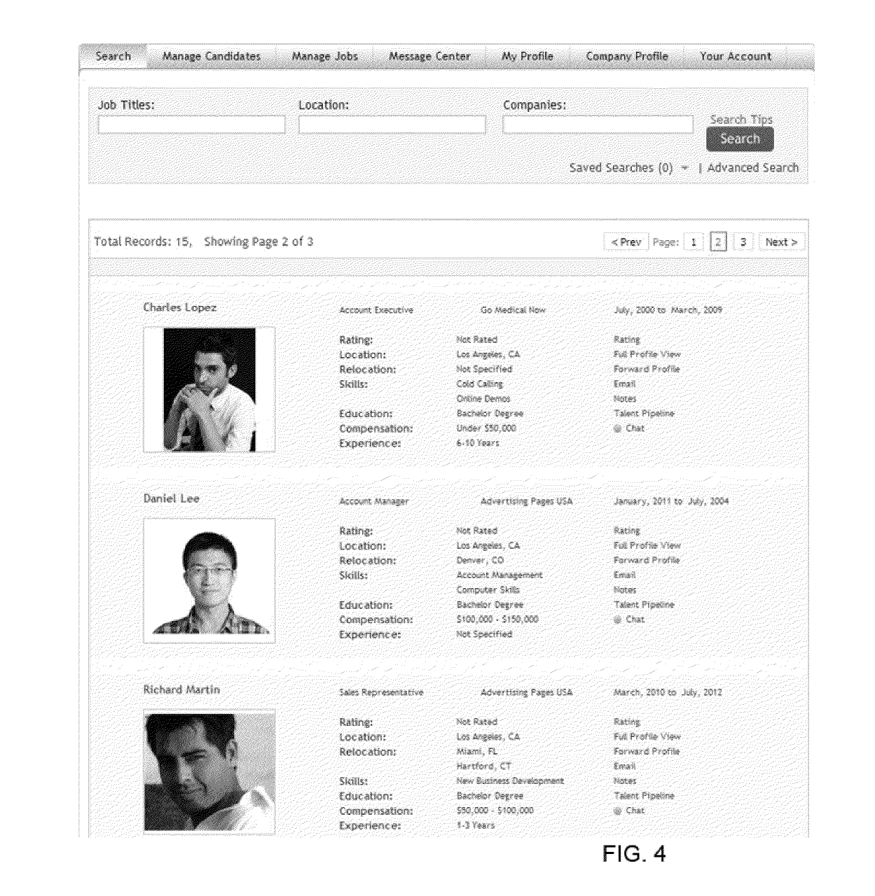

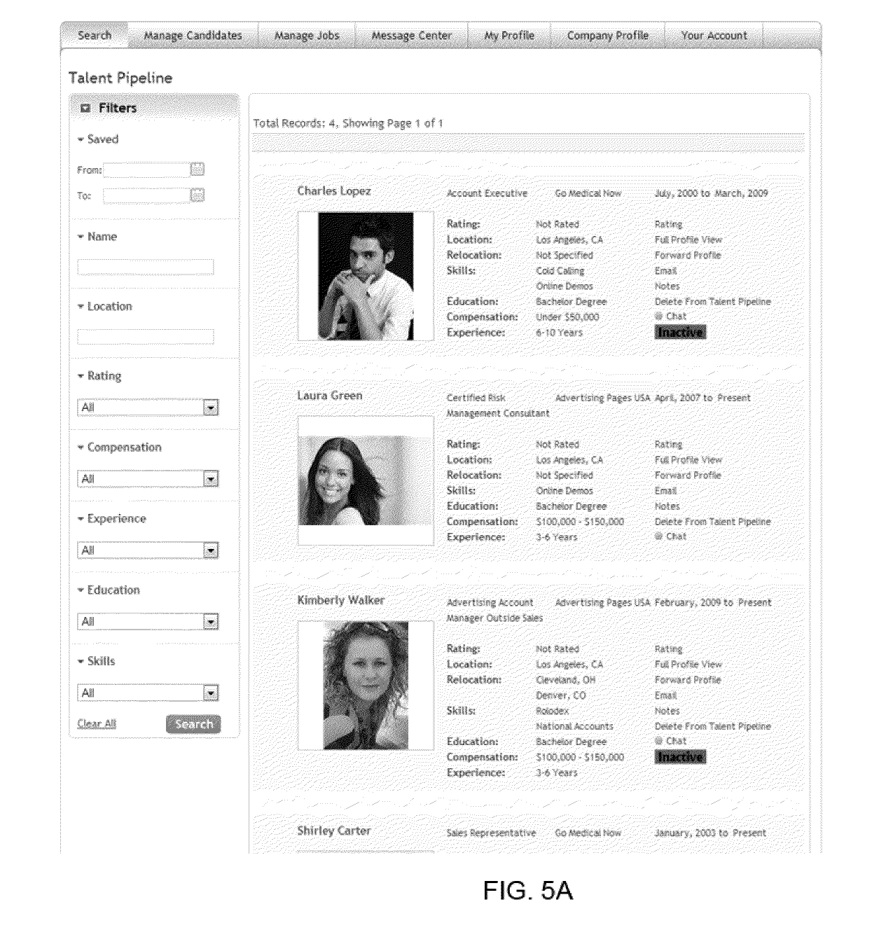

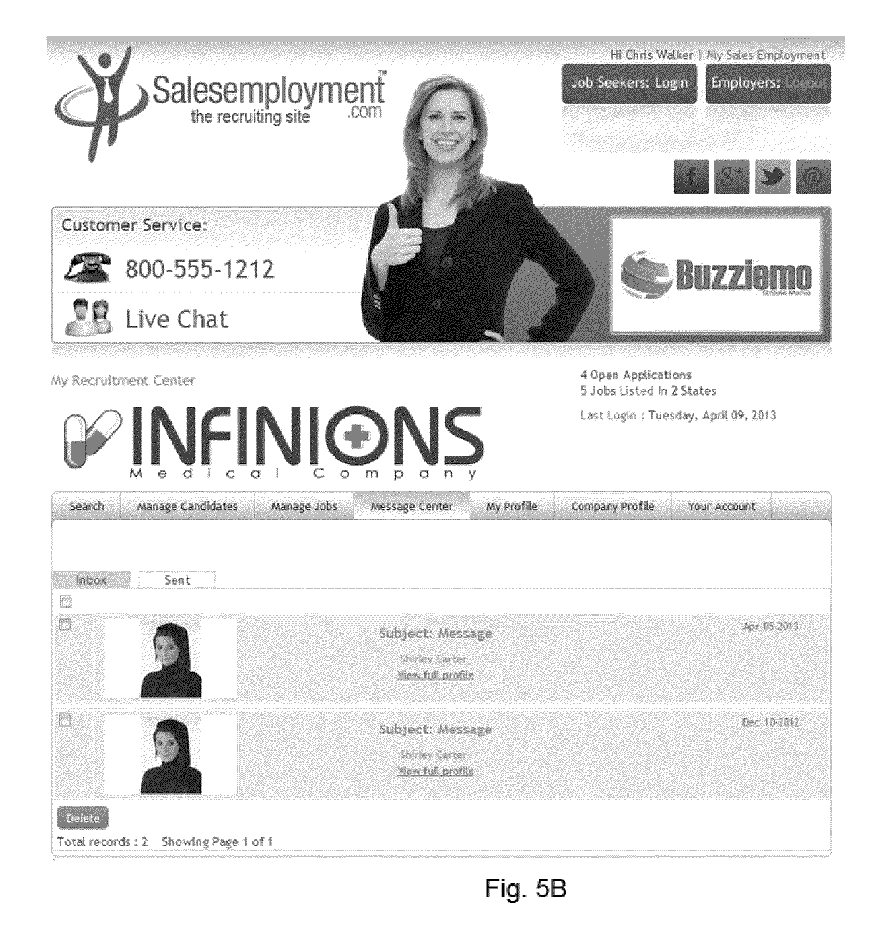

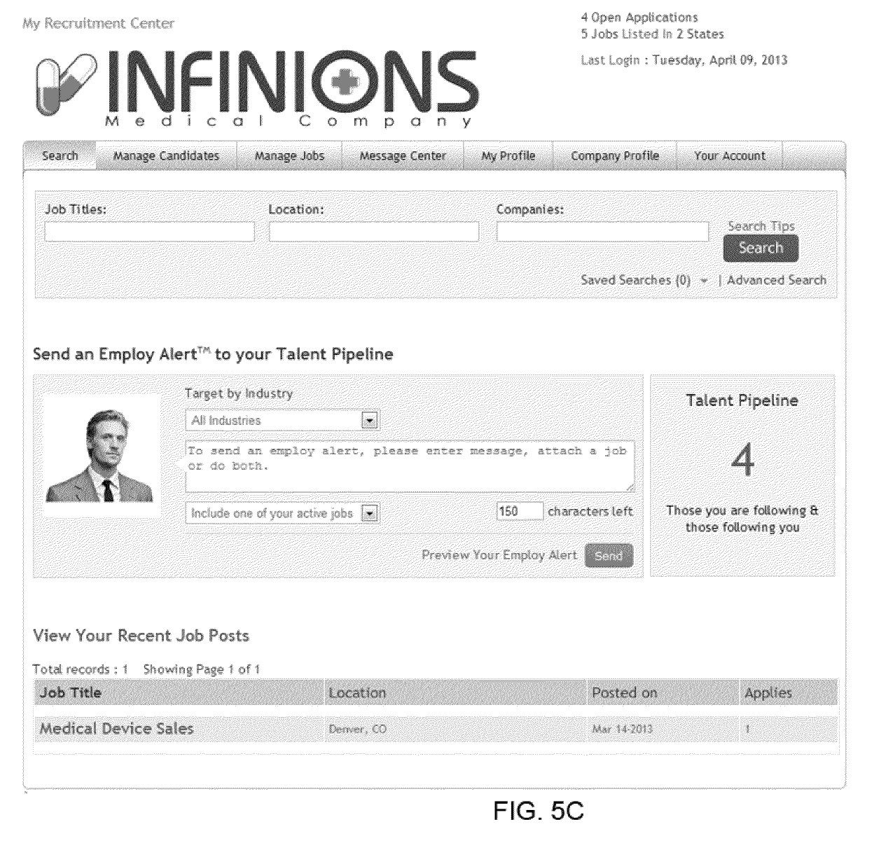

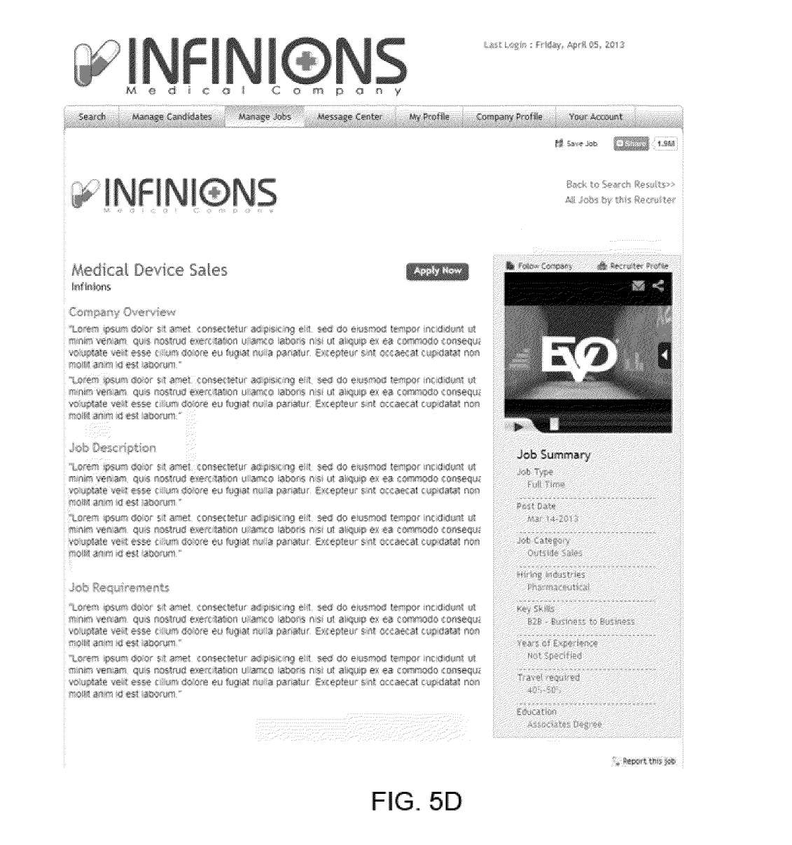

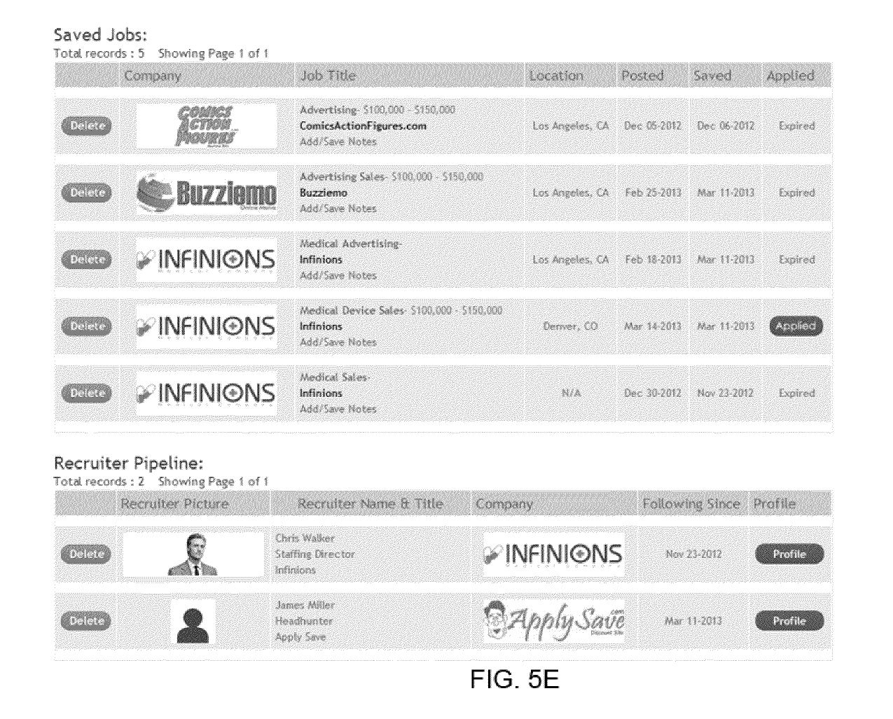

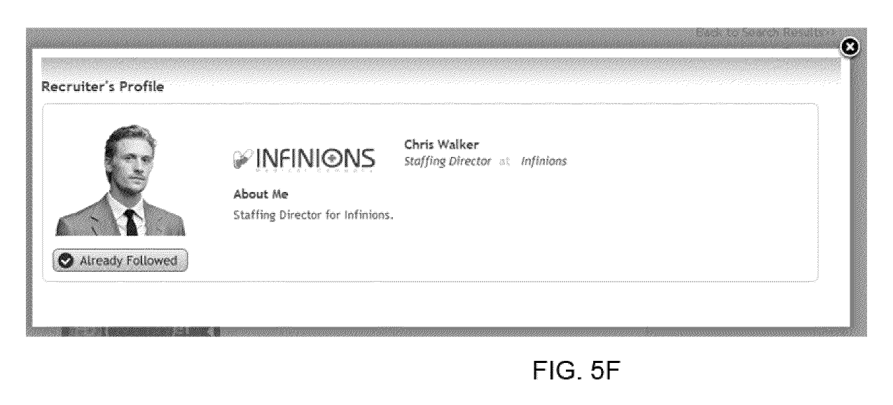

According to an embodiment of the present invention, the system may be configured to provide employers a mini-candidate profile view. The mini-candidate profile view may be constructed by the organization module and provided to the computing device of the employer, with the mini-candidate profile view being comprised of a subset of the premium candidate profile that would otherwise be provided. In preferred embodiments, the mini-candidate profile view is utilized to show multiple candidates on a single view result page and may further include a communication connection component that would allow the employer to immediately contact the candidate(s) via one or more communications means (e.g., VOIP, SMS, email, online chat). An exemplary embodiment of the mini-candidate profile view can be seen in FIG. 4. Here, three candidates are shown, with a limited amount of profile information being displayed for each potential candidate. The employer is provided the ability to connect immediately with any of the candidates via the “Chat” button on the min-candidate profile view. Further, these mini-candidate profile views (as well as premium profiles) can be filtered on or more criteria selected by the employer (See FIG. 5A). One of ordinary skill in the art would appreciate that there are numerous criteria for which an employer can search/filter candidates on, and embodiments of the present invention are contemplated for use with any such criteria.

According to an embodiment of the present invention, the system may be configured to provide a message center whereby candidates, employers and recruiters can store, retrieve and send messages (See, FIG. 5B).

According to an embodiment of the present invention, the system may also be configured to allow employers the ability to quickly store and retrieve various candidates they are potentially interested in hiring or contracting with (i.e., the Talent Pipeline) (See, FIG. 5C). These may be candidates that the employer or recruiter has no current jobs for, but are interested in these particular candidates for any number of reasons (e.g., education, skills, talent). Selection of candidates to save may be done either from the individual premium candidate profiles or in any number from the mini-candidate profile view pages. Candidates may also be able to follow particular recruiters or employers, allowing following to be bidirectional (See FIG. 5C). Employers may be also provided numerous tools for tracking these candidates, such as the ability to record notes related to each candidate, conversations with the candidates and a candidate ranking system, whereby an employer is provided, via the system, a list of candidates ranked in the order selected by the employer. In a preferred embodiment, a ranking list could be displayed with the various candidates' mini-candidate profile views. One of ordinary skill in the art would appreciate that there are numerous tools that could be provided by the system to employers for tracking candidates, and embodiments of the present invention are contemplated for use with any such tools.

According to an embodiment of the present invention, the system may allow recruiters or employers to send messages to everyone in their talent pipeline, or one or more selected individuals in their talent pipeline (See, FIG. 5C). In preferred embodiments, these messages are regarding employment opportunities or questions the recruiter/employer may have about the various candidates. For instance, a recruiter may send a job listing to those in its talent pipeline (See, FIG. 5D)

In certain embodiments, the system may allow candidates to see what recruiter pipelines they are in (See, FIG. 5E). Generally, this denotes a bidirectional following relationship between recruiter and candidate. However, in certain embodiments, candidates may be made aware that they are in a recruiter's pipeline if that recruiter follows them (puts them in their talent pipeline) without requiring the candidate follow them back. Candidates may also be able to review information regarding particular recruiters/employers via a recruiter profile or recruiter mini-profile view (See, FIG. 5F).

According to an embodiment of the present invention, the system may provide candidates the ability to provide external links to their profiles. In this manner, candidates can direct individuals to their specific profile. In certain embodiments, the external links may be generated such that a person following the link is directed directly to a specific portion of the profile (e.g., as specific tab) or a specific piece of premium profile information (e.g., brag book, video response to a particular question).

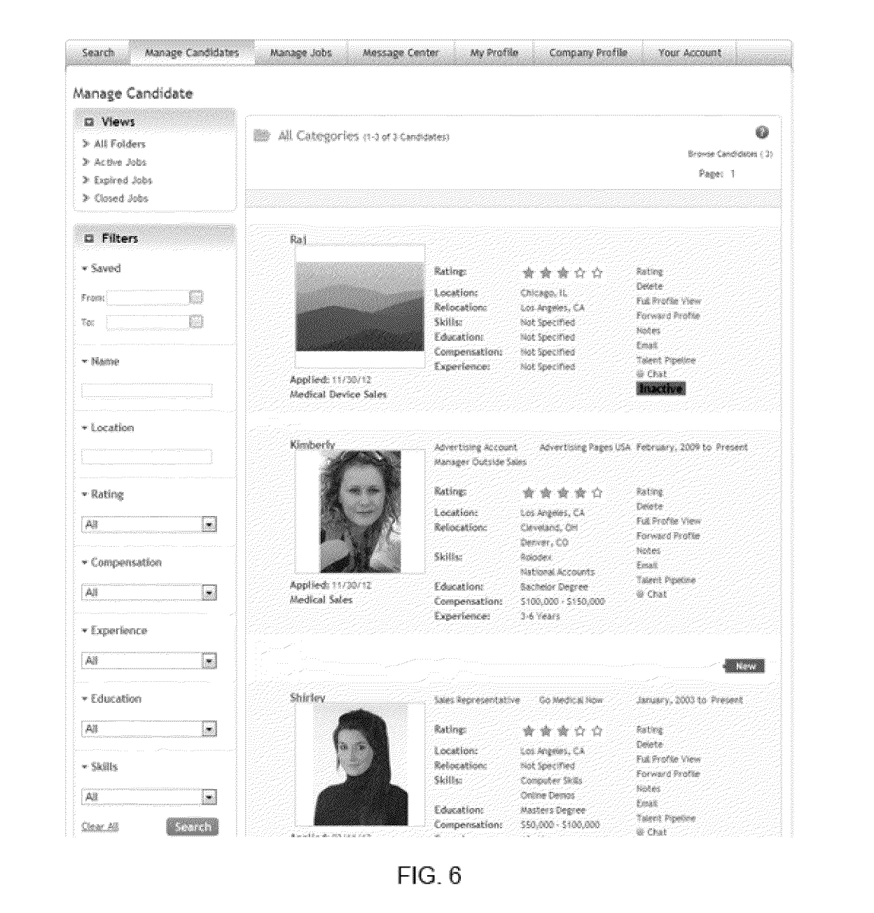

According to an embodiment of the present invention, the system may be configured to provide the ability for employers/recruiters to manage candidates through a specific area (See FIG. 6). Here, employers may be allowed to review responses to their job postings. The system may be configured to store job postings in selected folders. In a preferred embodiment, an employer may be provided ad responses separate from their talent pipeline postings/responses but both mini and premium candidate profiles may be connected or available for viewing to each. The system may also be configured to allow an employer to select a candidate from an ad response to place candidate in their talent pipeline.

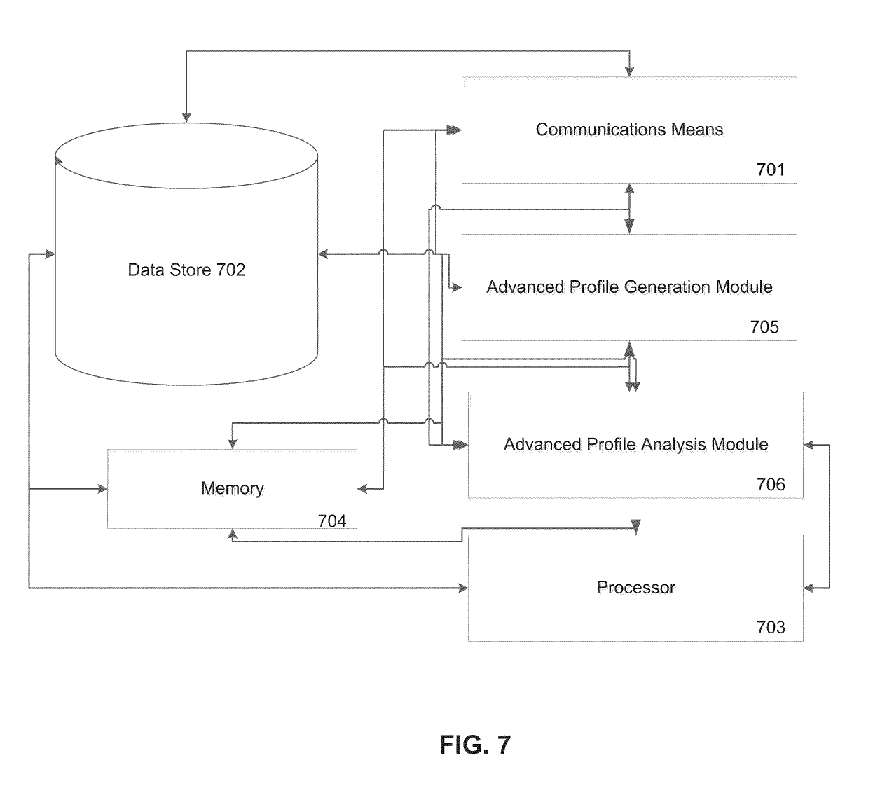

Turning to FIG. 7, according to an embodiment of the present invention, a system for generating design templates is comprised of one or more communications means 701, one or more data stores 702, a processor 703, memory 704, an advanced profile generation module 705 (sometimes referred to as the organizational module herein) and an advanced profile analysis module 706. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data over one or more networks or to one or more peripheral devices attached to the system. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, the advanced profile generation module is configured to allow for the receipt of profile information and premium profile information from potential employees and generate premium profiles for those potential employees in accordance with the methods described herein. The advanced profile generation module is configured to be operably and communicatively connected to the communications means, the advanced profile analysis module, processor, memory and data store in order to effect its purposes.

According to an embodiment of the present invention, the advanced profile analysis module is configured to provide potential employers with the abilities described herein related to generated premium profiles, including, but not limited to, searching, sorting, filtering, communicating with, ranking and maintaining a pipeline of potential employees for each potential employer. The advanced profile analysis module is configured to be operably and communicatively connected to the communications means, the advanced profile generation module, processor, memory and data store in order to effect its purposes.

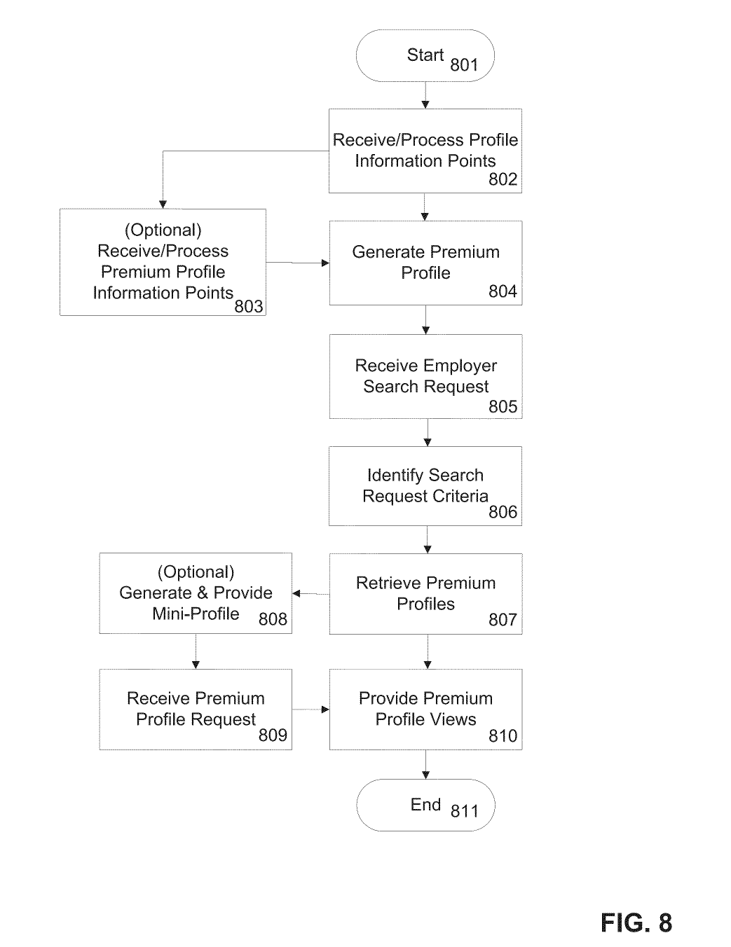

Turning now to FIG. 8, a method for providing applicant specific premium candidate profiles, in accordance with an embodiment of the present invention, is shown. The process starts at step 801 with a user interacting with the system. This method details the generation and review of a premium profile, and as such, the system, at step 802, receives profile information points related to the user from the user. The system processes these profile information points and begins to organize the various points in accordance with the disclosure herein.

Optionally, at step 803, the system received additional premium profile information points from the user. Once processed, the system sets about generating a premium profile (step 804). At this point, the user (e.g., potential employee) is set for inclusion in searches by potential employers using the system.

At step 805, a potential employer is interacting with the system and provides the system with criteria related to an employment position the potential employer is attempting to fill. At step 806, the system extracts employment criteria from the request for use in the search and identification of candidates for the position.

At step 807, the system retrieves one or more premium profiles stored in the system and relating to potential employees that match the potential employer's identified criteria. Optionally, the system may also generate mini-profiles and provide the mini-profiles to the potential employer to help display the potential employees in an easily viewable manner with data relevant to the potential employer's identified criteria (step 808). The potential employer may then select one or more potential employees to review, providing a request to the system which is received and processed at step 809.

In any case, the system, at step 810, retrieves the identified premium profile views and presents them to the potential employer. At this time the potential employer can interact with the premium profiles and contact the potential employees at their convenience and in a manner as detailed herein. At this point the process terminates at step 811.

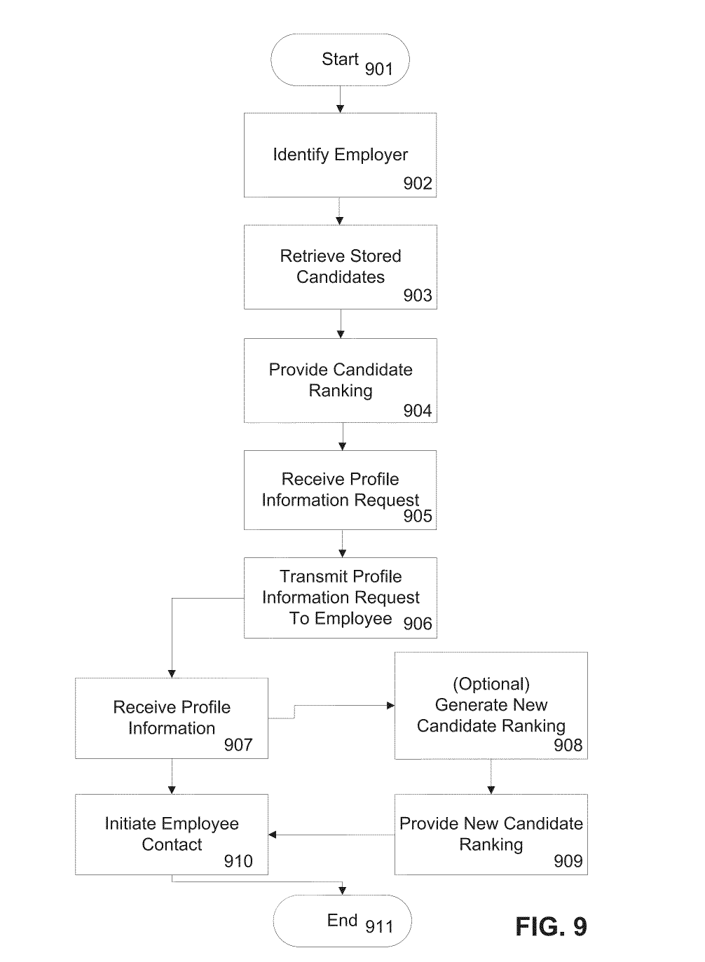

Turning now to FIG. 9, a method for providing applicant specific premium candidate profiles, in accordance with an embodiment of the present invention, is shown. The process starts at step 801 with an employer interacting with the system. This method details the ranking of stored candidates and certain interactions an employer may take with a potential employee, and as such, the system, at step 902, receives information related to an employer that allows the system to identify the employer (e.g., username, password, email).

At step 903, in response to a request to review stored candidates, the system retrieves stored candidates associated with the employer. At step 904, the system retrieves a candidate ranking formed by information provided by the employer, whether a direct ranking by the employer or a ranking based on approximation of profile information related to employer's identified criteria.

At step 905, the system receives a request from the employer about a candidate's profile. Specifically, where a candidate's profile is lacking in a piece of information important to the employer, the employer may request that the candidate provide that information so the employer can make an accurate judgment of the candidate with respect to potential employment with the company.

At step 906, the system sends a profile information request to the candidate identified by the employer. Assuming the candidate chooses to respond, the system will receive the profile information and add the profile information to the candidate's profile (step 907).

Optionally, at step 908, the system will recalculate and generate a new candidate ranking based on the newly received profile information. The new profile information may move the providing candidate up or down the candidate rankings, depending on the contents of the new profile information. If a new candidate ranking is generated, the system provides the updated ranking to the employer at step 909.

At step 910, the employer has selected one or more candidates to contact with respect to an employment position and the system initiates contact between the potential employee (i.e., candidate) and the employer. The method and manner of the contact can be any of the methods for contact provided for herein. At this point, the process terminates at step 911.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation ASP.Net, C, C++, Java, JavaScript, assembly language, Lisp, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

The functions, systems and methods herein described could be utilized and presented in a multitude of languages. Individual systems may be presented in one or more languages and the language may be changed with ease at any point in the process or methods described above. One of ordinary skill in the art would appreciate that there are numerous languages the system could be provided in, and embodiments of the present invention are contemplated for use with any language.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A computer implemented web-based method for providing applicant specific premium candidate profiles, said method comprising the steps of:
receiving a plurality of profile information points from a user;
processing said plurality of profile information points for compatibility with a premium candidate profile;
generating a premium candidate profile based on said plurality of profile information points;
receiving an employee search request from a potential employer;
identifying search criteria based at least in part on said employee search;
retrieving, from a data store, a set of premium candidate profiles comprising one or more premium candidate profiles, wherein each of said one or more premium candidate profiles matches at least a portion of said search criteria; and
providing said set of premium candidate profiles to said potential employer.

2. The computer implemented web-based method of claim 1, further comprising the steps of:
receiving one or more premium profile information points;
processing said one or more premium profile information points; and
augmenting said premium candidate profile with said premium profile information points.

3. The computer implemented web-based method of claim 2, wherein said premium profile information points are selected from the group comprising brag books, video profiles and selective questionnaire responses.

4. The computer implemented web-based method of claim 1, wherein said profile information points are selected from the group comprising candidate personal information, candidate experience information, candidate education information and candidate accomplishment information.

5. The computer implemented web-based method of claim 1, further comprising the steps of:
generating a mini-profile view for each premium candidate profile contained in said set of premium candidate profiles;
generating a display comprising mini-profile views generated for each premium candidate profile; and
providing said display to said potential employer.

6. The computer implemented web-based method of claim 5, further comprising the steps of:
providing a communication connection for instant communication between said potential employer and a candidate associated with said premium candidate profile, wherein said communication connection is initiated via interaction with said mini-profile view.

7. The computer implemented web-based method of claim 1, further comprising the steps of:
generating a candidate ranking based on a matching of said search criteria with profile information associated with each of said premium candidate profile in said set of premium candidate profiles; and
providing candidate ranking to said potential employer.

8. The computer implemented web-based method of claim 6, further comprising the steps of:
receiving an information request from said potential employer related to one of said premium candidate profiles in said set of premium candidate profiles;
transmitting said information request to a candidate associated with said one of said premium candidate profiles in said set of premium candidate profiles;
receiving supplementary profile information associated with said information request from said candidate;
processing said supplementary profile information associated with said information request from said candidate;
updating said one of said premium candidate profiles in said set of premium candidate profiles based at least in part on said supplementary profile information;
generating an updated candidate ranking, wherein an updated premium candidate profile changes the candidate ranking; and
providing said updated candidate ranking to said potential employer.

9. The computer implemented web-based method of claim 1, further comprising the steps of:
receiving a candidate contact request from said potential employer, wherein said candidate contact request identifies a premium candidate profile contained in said set of premium candidate profiles;
identifying contact information associated with a candidate in identified premium candidate profile; and
initiating contact between said potential employer and said candidate.

10. The computer implemented web-based method of claim 1, further comprising the steps of:
dividing the profile information points into a plurality of separate content sections;
associating said separate content sections with said premium candidate profile.

11. A computer implemented web-based system for providing applicant specific premium candidate profiles, said system comprising:
an advanced profile generation module, comprising computer-executable code stored in non-volatile memory,
an advanced profile analysis module, comprising computer-executable code stored in non-volatile memory,
a processor, and
a communications means,
wherein said advanced profile generation module, said advanced profile analysis module, said processor, and said communications means are operably connected and are configured to:
receive a plurality of profile information points from a user;
process said plurality of profile information points for compatibility with a premium candidate profile;
generate a premium candidate profile based on said plurality of profile information points;
receive an employee search request from a potential employer;
identify search criteria based at least in part on said employee search;
retrieve, from a data store, a set of premium candidate profiles comprising one or more premium candidate profiles, wherein each of said one or more premium candidate profiles matches at least a portion of said search criteria; and
provide said set of premium candidate profiles to said potential employer.

12. The computer implemented web-based system of claim 11, wherein said advanced profile generation module, said advanced profile analysis module, said processor, and said communications means are further configured to:
receive one or more premium profile information points;
process said one or more premium profile information points; and
augment said premium candidate profile with said premium profile information points.

13. The computer implemented web-based system of claim 12, wherein said premium profile information points are selected from the group comprising brag books, video profiles and selective questionnaire responses.

14. The computer implemented web-based system of claim 11, wherein said profile information points are selected from the group comprising candidate personal information, candidate experience information, candidate education information and candidate accomplishment information.

15. The computer implemented web-based system of claim 11, wherein said advanced profile generation module, said advanced profile analysis module, said processor, and said communications means are further configured to:
generate a mini-profile view for each premium candidate profile contained in said set of premium candidate profiles;
generate a display comprising mini-profile views generated for each premium candidate profile; and
provide said display to said potential employer.

16. The computer implemented web-based system of claim 15, wherein said advanced profile generation module, said advanced profile analysis module, said processor, and said communications means are further configured to:
provide a communication connection for instant communication between said potential employer and a candidate associated with said premium candidate profile, wherein said communication connection is initiated via interaction with said mini-profile view.

17. The computer implemented web-based system of claim 11, wherein said advanced profile generation module, said advanced profile analysis module, said processor, and said communications means are further configured to:
generate a candidate ranking based on a matching of said search criteria with profile information associated with each of said premium candidate profile in said set of premium candidate profiles; and
provide candidate ranking to said potential employer.

18. The computer implemented web-based system of claim 11, wherein said advanced profile generation module, said advanced profile analysis module, said processor, and said communications means are further configured to:
receive an information request from said potential employer related to one of said premium candidate profiles in said set of premium candidate profiles;
transmit said information request to a candidate associated with said one of said premium candidate profiles in said set of premium candidate profiles;
receive supplementary profile information associated with said information request from said candidate;
process said supplementary profile information associated with said information request from said candidate;
update said one of said premium candidate profiles in said set of premium candidate profiles based at least in part on said supplementary profile information;
generate an updated candidate ranking, wherein an updated premium candidate profile changes the candidate ranking; and
provide said updated candidate ranking to said potential employer.

19. The computer implemented web-based system of claim 11, wherein said advanced profile generation module, said advanced profile analysis module, said processor, and said communications means are further configured to:
receive a candidate contact request from said potential employer, wherein said candidate contact request identifies a premium candidate profile contained in said set of premium candidate profiles;
identify contact information associated with a candidate in identified premium candidate profile; and
initiate contact between said potential employer and said candidate.

20. The computer implemented web-based system of claim 11, wherein said advanced profile generation module, said advanced profile analysis module, said processor, and said communications means are further configured to:
divide the profile information points into a plurality of separate content sections;
associate said separate content sections with said premium candidate profile.
